(19) United States
(12) Patent Application Publication
(10) Pub. No.: US 2022/0131176 A1
(43) Pub. Date: Apr. 28, 2022

(54) METHOD AND APPARATUS FOR ASSEMBLING CELLS

(71) Applicant: MANZ ITALY S.R.L., SASSO MARCONI (BO) (IT)

(72) Inventors: Massimiliano Sale, SASSO MARCONI (BO) (IT); Stefano Saguatti, SASSO MARCONI (BO) (IT); Pasqualino Alongi, SASSO MARCONI (BO) (IT); Carlo Innocenti, SASSO MARCONI (BO) (IT)

(21) Appl. No.: 17/431,020

(22) PCT Filed: Mar. 11, 2020
(86) PCT No.: PCT/IB2020/052158

§ 371 Date: Aug. 13, 2021

(30) Foreign Application Priority Data
Mar. 11, 2019 (IT) 102019000003489

(51) Int. Cl. H01M 10/04

(52) U.S. Cl. CPC H01M 10/0404

(57) ABSTRACT

A method and apparatus for assembling electrochemical cells for producing power energy accumulation devices are disclosed, wherein flat shaped cells are fed, arranged in a horizontal lay, to a release zone where cells are pushed downwards, one at a time, towards a stacking zone where a stack of superimposed cells is formed, a portion of a perimeter flexible flap of each cell being bent upwards during the descent by effect of contact with at least a guiding slide, and then, continuing the descent, such contact terminates thereby an elastic return of the portion of flexible flap occurs.

### CROSS-REFERENCE TO RELATED APPLICATIONS

This Patent application claims priority from Italian Patent Application No. 102019000003489 filed on Mar. 11, 2019, the entire disclosure of which is incorporated herein by reference.

### BACKGROUND OF THE INVENTION

The invention relates to a method and apparatus for assembling cells, in particular for stacking electrochemical cells one on top of the other.

Specifically, though not exclusively, the invention may be applied to produce electrical energy storage devices, e.g. lithium batteries.

Patent Publication WO 2018/096435 A1 shows an assembling method and apparatus wherein a plurality of electrochemical cells are stacked one on top of the other to form an electrical energy storage device.

One of the problems of the prior art is stacking electrochemical cells with a high geometrical precision, as each error in superimposing cells between them can result in a yield drop and/or in a decrease in the electrical energy storage device efficiency.

Another problem is stacking cells with a high productivity and without causing any damage to cells themselves.

### SUMMARY OF THE INVENTION

An object of the invention is to realise a method and/or apparatus capable to overcome one or more of the aforementioned problems of the prior art.

An advantage is to provide an assembling method and/or apparatus adapted to produce electrical energy storage devices.

An advantage is to enable stacking cells with a high precision in superimposing cells.

Other advantages are stacking cells with a high productivity and without causing any damage to cells themselves.

An advantage is to allow producing high-quality electrical energy storage devices with a high yield.

An advantage is to provide an apparatus for assembling electrochemical cells that is of simple and cheap construction.

Such objects and advantages and still others are reached by a method and/or apparatus according to one or more of the hereinafter reported claims.

In one example, a method for assembling flat shaped cells comprises the steps of feeding cells to a release zone, and pushing cells, one at a time, from the release zone towards a stacking zone where a stack of superimposed cells is formed, wherein during movement towards the stacking zone at least a portion of a perimeter flexible flap of each cell is bent due to contact with guide means and then, continuing the movement, contact with guide means terminates whereby an elastic return of the portion of a flexible flap occurs.

In one example, an assembling method comprises means for assembling flat shaped cells to a release zone, means to push cells, one at a time, from the release zone towards a stacking zone where a stack of superimposed cells is formed, and guide means configured to bend, due to contact, at least a portion of a perimeter flexible flap of each cell during the movement towards the stacking zone, said guide means being configured such that, continuing moving the cell, the contact with the portion of a flexible flap terminates whereby an elastic return of such portion can occur.

Guide means can comprise two or more guide portions, that are separated and distant from each other, each of which can comprise a sliding surface wherein the sliding friction is not excessive and such to guide the movement of the cell for positioning it correctly on the stack.

In particular, guide means allow to direct the cell towards the stacking zone by positioning it precisely, being also eased by the action of pushing means that push the cell by guide means, in particular according to a pushing direction that is mainly orthogonal to the lay plane of the cell.

In particular, pushing means can perform a stroke passing past guide means, for instance to guide the cell at least to a recessed zone, free or empty, located beyond guide means, where the perimeter flexible edge or flap of the cell can freely return in an unbent position. In particular, pushing means can perform a determined stroke to take the cell to the end (e.g. to the top) of the stack being formed in the stacking zone.

### BRIEF DESCRIPTION OF THE DRAWINGS

The invention shall be better understood and implemented referring to the appended drawings that illustrate a non-limiting embodiment thereof, wherein:

FIG. 1 is a perspective view of an example of an assembling apparatus realised according to the present invention;

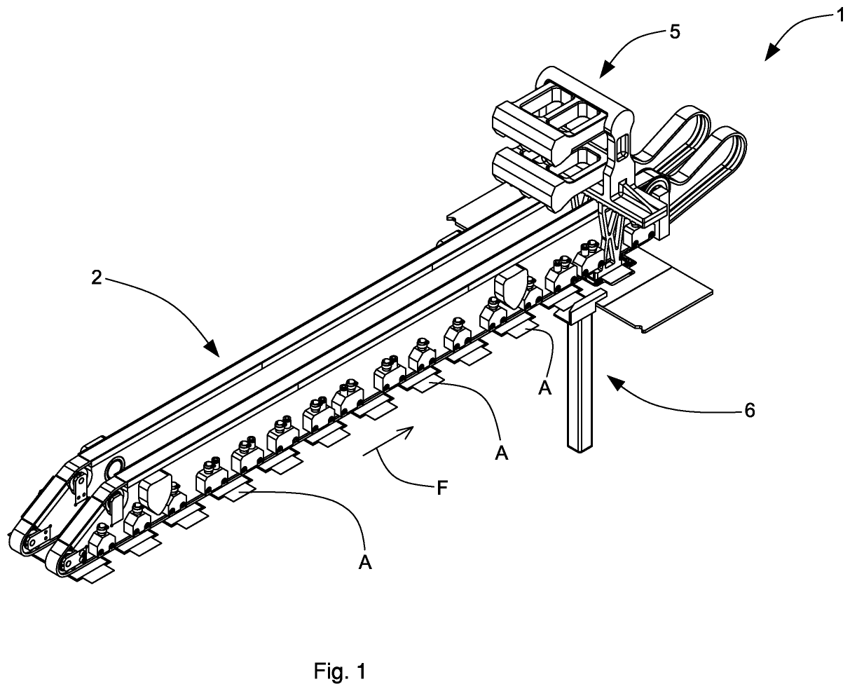

FIG. 2 is an enlarged detail of FIG. 1;

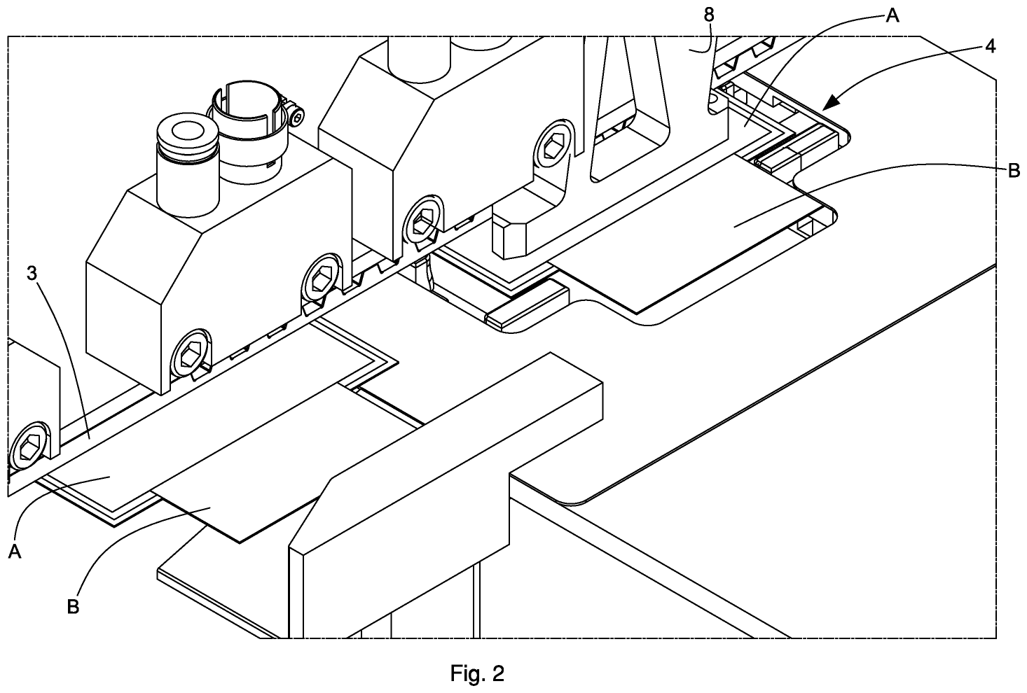

FIG. 3 is a plan view from above of the apparatus of FIG. 1;

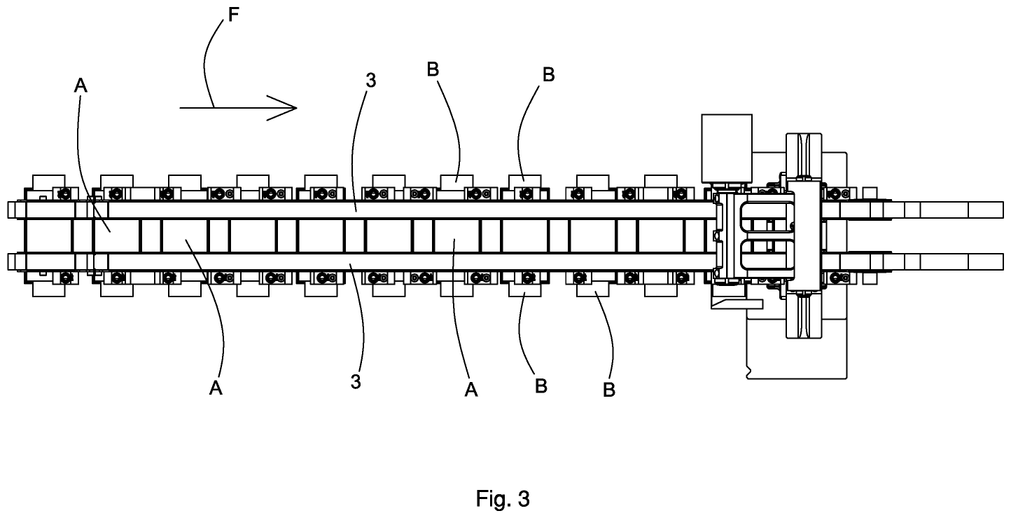

FIG. 4 is a side view from the left of FIG. 3;

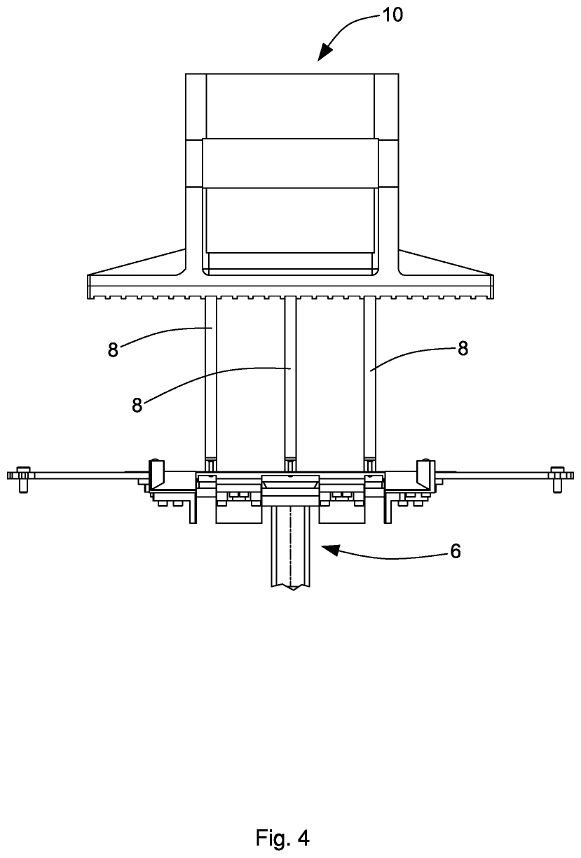

FIG. 5 is a side view from below of FIG. 3;

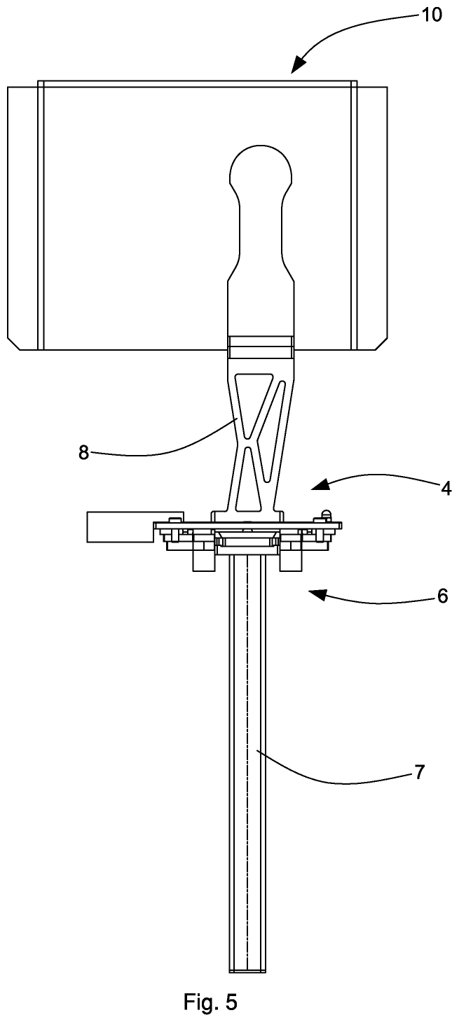

FIG. 6 is a vertical elevation front view of suction-belt conveyor means that feed the cells;

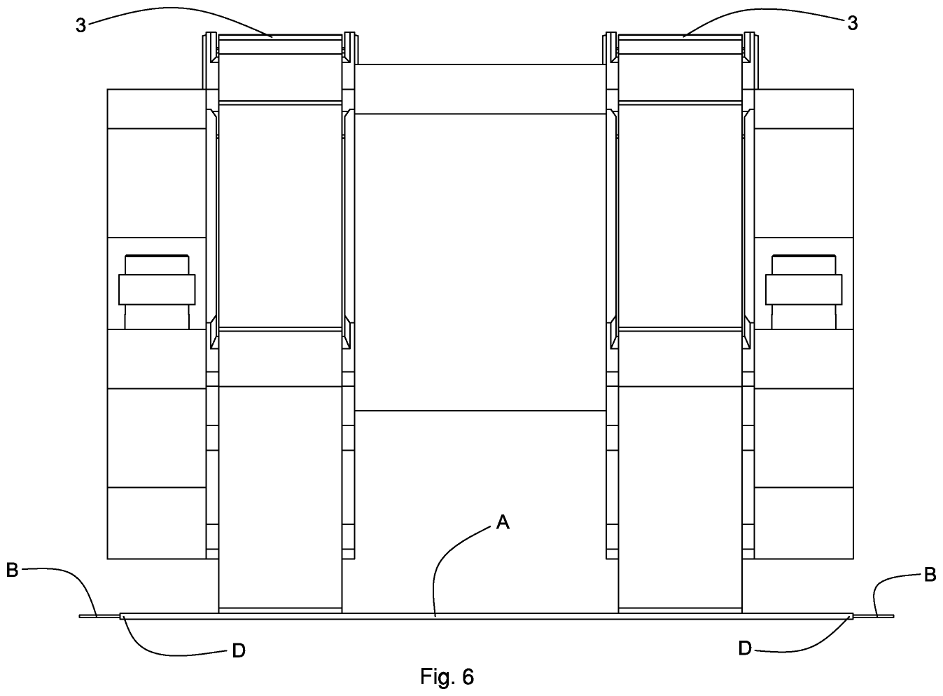

FIG. 7 is a perspective view of a detail of the apparatus of FIG. 1;

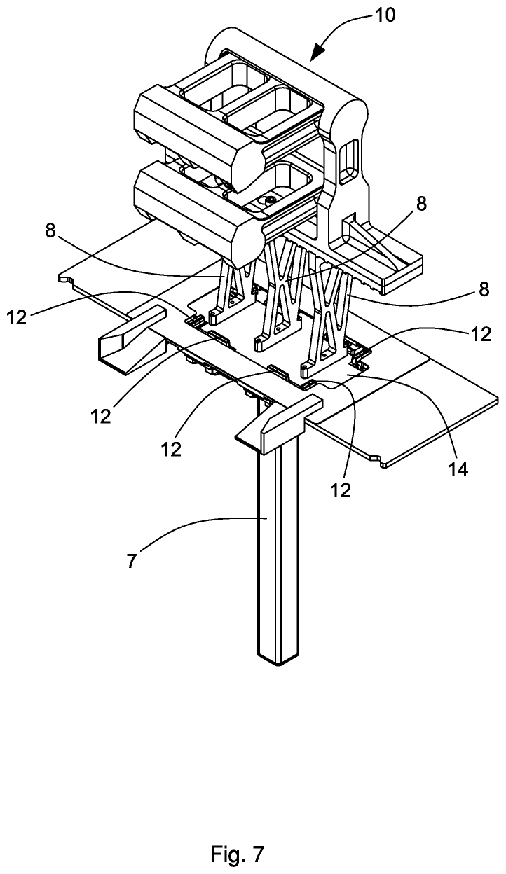

FIG. 8 shows an enlarged detail of the specifics of FIG. 7 according to a different perspective;

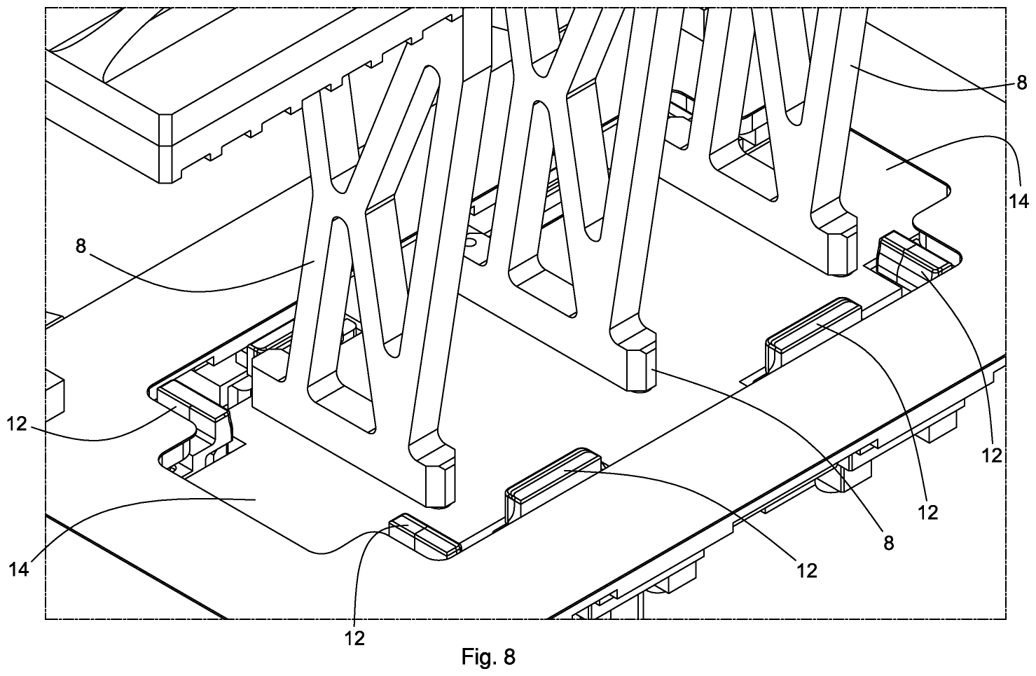

FIG. 9 is a side view from below of FIG. 4;

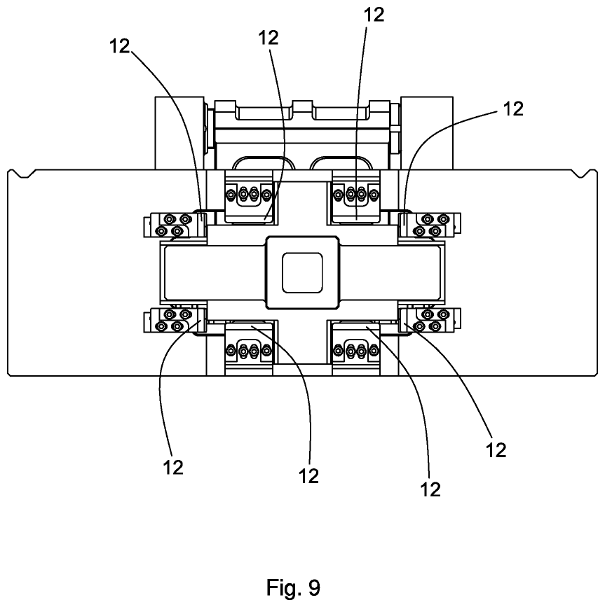

FIGS. 10 to 12 show three functioning steps of pushing means that push the cell towards the stacking zone;

FIGS. 13 to 15 show three enlarged details of the figures, respectively, 10 to 12;

FIGS. 16 to 18 show three examples, in section, of cells that can be processed in the cell assembling apparatus of FIG. 1.

### DETAILED DESCRIPTION

An assembling apparatus for assembling cells A, in particular for electrochemical cells that can be used to produce electrical energy storage devices, e.g. lithium batteries, is altogether indicated by 1.

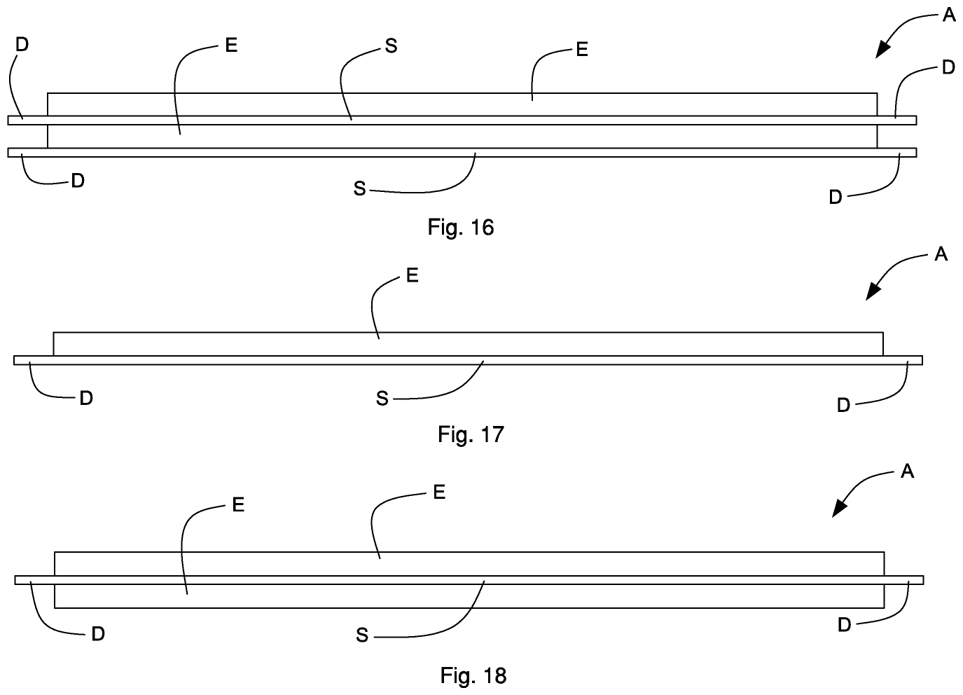

Each cell may in particular have a flat shape. Cells A may in particular be intended to be stacked one on top of the other to form an electrical energy storage device. Each cell A may in particular comprise at least an electrode E (e.g. an electrode sheet) and/or at least a separator S (e.g. a separator sheet) at least partly superimposed on each other. Cell A may comprise one or more separators S and one or more electrodes E. In particular cell A may comprise two electrodes E separated by at least a separator S. Each electrode E may comprise a cathode or an anode. Each electrode E may comprise at least a protruding tab B intended to form, in the electrical energy storage device, an electrical connection. In the example of FIG. 16, the cell A comprises two separators S and two electrodes E (an anode and a cathode). In the example of FIG. 17, cell A comprises a separator S and an electrode E (an anode or a cathode). In the example of FIG. 18, cell A comprises two separators S and an electrode E (an anode or a cathode).

Each cell A may in particular comprise at least an elastically flexible perimeter flap D, for instance a flap made of a material for separating electrodes. The separator S (separator sheet) may in particular have a surface extension greater than the electrode E (electrode sheet). The perimeter flap D of the cell A may in particular comprise a perimeter flap of the separator (sheet) S which protrudes beyond an edge of the electrode (sheet) E. Cell A may have a rectangular shape, as in this specific case, even if it is possible to provide cells of squared, polygonal, circular, oval shape, with rectilinear, curved or mixed edges (partly rectilinear and partly curved), cells shaped with more or less complicated shapes, and so on. The flexible perimeter flap D may in particular extend throughout the perimeter of the cell A. The flexible perimeter flap D may in particular be interrupted at the protruding tab/s B.

The distribution apparatus 1 may in particular comprise feeding means 2 configured to feed cells A of flat shape, arranged one after the other, in a feed direction F along a feed path. The feed path may comprise, as in this example, at least a horizontal portion. The feed path may comprise, as in this example, at least a rectilinear and horizontal portion. Feeding means 2 may be configured, in particular, to feed cells A arranged horizontally at least in a portion of the feed path. It is possible in any case to provide feeding cells A arranged in a lay that differs from the illustrated example, in particular with an oblique or vertical lay.

Feeding means 2 may in particular comprise movable conveyor means provided with suction means to keep cells A in grip. Conveyor means may in particular comprise actuating means adapted to originate a depression and at least a fluid-tight depression zone wherein the depression is originated, wherein cells A may communicate with the aforesaid depression zone while advancing along the feed path.

Feeding means 2 may in particular comprise conveyor means with at least one closed-loop sliding flexible conveyor element 3. In this specific example, conveyor means comprise two flexible conveyor elements 3 arranged parallel and spaced apart from each other. Flexible conveyor elements 3 may comprise, for instance, tapes or belts.

Conveyor means may comprise, as in this example, at least a movable portion extended along a direction (horizontal in this example) coincident with the advancement direction of cells. The aforesaid movable portion may in particular comprise at least a lower branch of a closed loop of a flexible conveyor element 3. Conveyor means, in particular of the suction type, may be configured so as to keep cells A in grip originating a depression arranged on a side (e.g. upper side) of cells themselves, in particular in such a way as to keep cells hanging from above. Conveyor means may be configured, as in this example, such to engage each cell A in a portion of the (upper) surface of the cell A and to keep another portion of the (upper) surface free, in order to push the cell A (in particular downwards) by pushing means that are able to contact the aforesaid free portion of surface, as it will be better explained hereinafter.

The distribution apparatus 1 may in particular comprise at least a release zone 4 at which cells A fed by feeding means 2 arrive. In particular, when they arrive in the release zone 4, cells A of flat shape may be arranged in a horizontal lay.

The distribution apparatus 1 may in particular comprise pushing means 5 configured to push (in particular downwards) a cell A in the release zone 4 transported by feeding means 2.

The distribution apparatus 1 may in particular comprise at least a stacking zone 6, in particular arranged at a quota that is lower than the release zone 4. Cells A are stacked one on top of the other in the stacking zone 6. The stacking zone 6 may comprise, for instance, a container 7 to contain the stack of cells A. The container 7 may comprise, for instance, an ordinary hopper for containing a (vertical) stack of electrochemical cells A. The stacking zone 6 may in particular be vertically arranged below the release zone 4.

The stacking zone 6 may in particular be provided with movable support means (e.g. vertically) that are configured to support the stack of cells A and to perform a movement (in particular a descent) while forming the stack such that the end (top) of the stack being formed substantially keeps the same position (quota). Movable support means may in particular comprise at least a (vertically) movable base plane, that is adapted to receive as a base the stack of cells A. The movable base plane may be controlled (e.g. by motor means that are in turn controlled by control programmable electronic means of the apparatus 1) such to perform a movement (e.g. a vertical downward movement), in particular intermittent (or continuous). In particular the movable base plane may be controlled to perform a stroke (descent) that is equal to the thickness of a cell A in the time lapse between the settlement of cell A on the end (top) of the stack and the settlement of the following cell A.

Pushing means 5 may in particular comprise at least a movable thrust unit provided with at least one or two rods 8 (or even three or more rods, according to the width of cell A), in particular vertical rods, each of which has a (lower) end configured to push the cell A arranged in the release zone 4. Pushing means 5 may be arranged, as in this example, to operate on a side (e.g. upper side) of a cell A located in the release zone 4. In particular, each contact end of the rod 8 may be configured to interact with the aforesaid free portion of (upper) surface of the cell A, namely the surface portion that is not engaged by suction conveyor means. In this specific example the movable unit comprises three (vertical) pushing rods 8, that include a central rod 8 arranged in the space between two conveyor elements 3, a lateral rod arranged outside on a side of the two conveyor elements 3, and another lateral rod arranged outside on the side opposite the two conveyor elements 3.

The thrust unit may be movable upon driving motor means (not illustrated, e.g. an electric engine). The thrust unit may be movable with a round-trip cyclic alternate motion (descent and rise), with a forward step (descent) wherein it pushes the cell A (downwards), in particular until the end of the stack, and a return step (rise) to an initial position. The thrust unit may be movable, in particular, with a translational motion.

The thrust unit may be in particular configured to exert a pushing force on the cell A with a pushing direction that is orthogonal or almost orthogonal to the lay of cell A.

The thrust unit may be connected, as in this example, to motor means by a mechanism 10 (only schematically represented in the figures) configured to transform a rotary motion (e.g. the motion of a rotor of motor means) into a translational motion (e.g. the motion of the thrust unit). The aforesaid mechanism 10 may in particular comprise a jointed parallelogram mechanism comprising a connecting rod bearing the thrust unit. The connecting rod may in particular comprise two ends jointed to two balance wheels each of which may be in turn jointed to a frame of apparatus 1. At least one of the two balance wheels may be connected to motor means by a mechanism which transforms a continuous rotary movement of a rotor of motor means into an alternate rotary motion of the balance wheel.

The distribution apparatus 1 may in particular comprise guide means 12 arranged in a portion of the (descent) path performed by cells A from the release zone 4 to the stacking zone 6. Guide means 12 may be configured in such a way as to touch at least a portion of a perimeter flexible flap of cell A during the movement (descent) of the cell itself and as to bend (in this example upwards) the aforesaid flap portion by effect of this contact. Guide means 12 may be configured so that the contact terminates still maintaining the movement (descent) of the cell A such that an elastic return of the flap portion (in this case downwards) can freely occur. Substantially, guide means 12 do not stop the movement (descent) of the cell A, but can engage a portion of the perimeter flexible edge or flap of cell A for a portion of the movement, so as to guide bending of the edge or flap thereof due to sliding contact, and later disengage the aforesaid edge portion and allow the elastic return of the flexible edge or flap.

In particular, at least a cavity 13 arranged beyond (in this example below) guide means 12 may be provided, such to define a free zone, or empty zone, which allows the flexible flap of the cell A, after passing past the guide means 12, to freely assume an unbent position, due to elastic return, substantially returning to an unbent shape, thus re-assuming its own configuration prior to the sliding contact against guide means 12.

Guide means 12 may in particular comprise at least two contact portions that are distant and separated from each other. The two aforesaid contact portions may be configured to sliding contact at least a perimeter side of the cell A in at least two zones that are distant from each other and separated from each other by a zone of the perimeter side where the sliding contact does not occur. Guide means 12 may in particular comprise at least a contact portion for each side of the cell A.

Guide means 12 may be configured to delimit at least in part an opening for the passage of the cell A in the movement path from the release zone 4 to the stacking zone 6.

Guide means 12 may comprise, as in this example, at least a contact surface configured to at least partly contact the perimeter flexible flap of the cell A. The aforesaid contact surface may in particular be inclined towards the direction of movement of the cell A (in this case downwards) and towards a central area of the aforesaid passage opening of the cell A, so as to gradually reduce the passage section.

The contact surface may in particular define a sliding guide surface to guide the perimeter flexible flap of the cell A.

The sliding guide surface may comprise at least an inclined plane surface. The sliding guide surface may in particular comprise at least a curved surface. The sliding guide surface may in particular comprise at least a concave surface or a convex surface. The sliding guide surface may in particular comprise at least a partly concave and partly convex surface, with an inflection which separates the concave part (upstream) from the convex part (downstream).

Guide means 12 may in particular be configured in such a way to contact the perimeter flap of the cell A at least on a first perimeter side of the cell A and at least on a second perimeter side of the cell A opposite to the first side.

Guide means 12 may in particular comprise at least two first contact portions configured to contact two first zones of a perimeter first side of the cell A and at least two second contact portions configured to contact two second zones of a perimeter second side of the cell A (opposite the first side). The two first contact portions may be distant and separated from each other by a zone where contact does not occur. The two second contact portions may be distant and separated from each other by a zone where contact does not occur.

Guide means 12 may in particular comprise at least two third contact portions configured to contact two third zones of a perimeter third side of the cell A and at least two fourth contact portions configured to contact two fourth zones of a perimeter fourth side of the cell A (opposite the first side). The two aforesaid third contact portions may be distant and separated from each other by a zone where contact does not occur. The two aforesaid fourth contact portions may be distant and separated from each other by a zone where contact does not occur.

Guide means 12 may comprise, as in this specific example, eight contact portions that are arranged to interact by sliding contacting two-by-two the four sides of a cell A (in this case rectangular-shaped). It may in particular be provided that some contact portions are provided with a sliding guide surface with inclined plane shape, and other contact portions are provided with a sliding guide surface of curved shape, for instance concave, or convex, or partly concave and partly convex with a separation inflection.

It may in particular be provided that at least one or two contact portions of guide means 12 arranged on a first side of the passage opening have an inclined plane shape and at least one or two contact portions of guide means 12 arranged on a second side of the passage opening, opposite to the first side, also have an inclined plane shape. It may in particular be provided that at least one or two contact portions of guide means 12 arranged on a third side of the passage opening (transversal to the first side and the second side) have a curved shape (concave, or convex, or partly concave and partly convex with a separation inflection) and at least one or two contact portions of the guide means 12 arranged on a fourth side of the passage opening, opposite the third side, also have a curved shape (concave, or convex, or partly concave and partly convex with a separation inflection).

Guide means 12 may in particular be configured in such a way as to contact the perimeter flap of the cell A on two opposite perimeter sides of the cell A and subsequently on other two opposite perimeter sides of the cell A. Guide means 12 may comprise an initial portion (e.g. two pairs of contact portions) arranged to operate on two opposite perimeter sides of the cell A and a following portion (e.g. other two pairs of contact portions) arranged to operate on other two opposite perimeter sides of the cell A, in which the following portion of guide means 12 is arranged beyond the initial portion (e.g. of a few millimetres or tenths of millimetres), where “beyond” is referred to the movement direction of the cell A (in this specific example “beyond” means “at a lower quota”). In particular, the following portion of guide means 12 may be arranged in such a way to start contacting the perimeter flap of the cell A when the initial portion is still in contact with the perimeter flap of the cell A.

Guide means 12 may in particular comprise sliding guide surfaces made of a material with a relatively low friction coefficient, for instance metal surfaces submitted to a surface hardening treatment that is adapted to reduce the friction coefficient (and to increase sliding wear resistance).

The passage opening of the cell A arranged between the release zone 4 and the stacking zone 6 may in particular comprise at least a recess 13 adapted to allow the free passage, without contact, of tab B. In this specific example, wherein each cell A comprises two electrodes E (a cathode and an anode) and hence two tabs B (on two opposite sides of cell A) the passage opening of the cell A comprises two recesses 13 suitable for the free passage of the two tabs B.

The functioning of the assembling apparatus 1 implements an assembling method of cells A which can comprise, in particular, the step of feeding cells A of flat shape, arranged one after the other, in a feed direction F, to a release zone 4.

The assembling method may in particular comprise the step of pushing the cell A (e.g. downwards), when the cell A arrives at the release zone 4, in order to make it perform a movement (descent) towards a stacking zone 6 where cells form a stack of cells superimposed on each other.

The assembling method may in particular comprise the step of bending at least a portion of a perimeter flexible flap of the cell A, during the movement, with a bending in a direction opposite to the movement thereof (in this example, with an upward bending), by effect of the sliding contact with guide means 12. The assembling method may in particular comprise the subsequent step of terminating the aforesaid sliding contact, continuously maintaining the cell A movement, such that an elastic return of the portion of flexible flap can occur (in a free space, or empty space).

As seen, the aforesaid sliding or slipping contact, which causes the bending of the flexible edge or flap of cell A and allows to precisely guide the movement of the cell A and to position it correctly on the stack being formed in the stacking zone 6, may occur at least on a perimeter side of cell A, for instance in at least two zones that are distant from each other and separated from each other by a side portion where the contact does not occur.

It was also seen that guide means 12 may delimit at least in part an opening for the passage of the cell during its continuous movement towards the stacking zone 6 and that the sliding contact which guides the movement of the cell A may occur on a contact or sliding surface of guide means 12 which is inclined towards the moving direction of the cell (A) and towards a central zone of the aforesaid passage opening of the cell.

The aforesaid sliding contact and guide may occur on at least one first perimeter side of cell A and on at least one second perimeter side of cell A opposite the first side. The aforesaid sliding contact and guide may occur in at least two first zones arranged on the first perimeter side of cell A and in at least two second zones arranged on the second perimeter side of cell A. The two first zones may be distant from each other and separated from each other by a side portion where the aforesaid contact does not occur. The two second zones may be distant from each other and separated from each other by a side portion where contact does not occur.

The aforesaid sliding contact and guide may occur at least on a third perimeter side of cell A and on at least one fourth perimeter side of the cell opposite the third side. The aforesaid sliding contact and guide may occur in at least two third zones arranged on the third perimeter side and in at least two fourth zones arranged on the fourth perimeter side. The two third zones may be distant from each other and separated from each other by a side portion where the aforesaid contact does not occur. The two fourth zones may be distant from each other and separated from each other by a side portion where the aforesaid contact does not occur.

The assembling method may in particular provide that, during the step of feeding the cells towards the release zone 4, cells themselves are kept in grip by means of movable conveyor means provided with suction means.

The assembling method may in particular provide that each cell A arrives at the release zone 4 (horizontally arranged) and is pushed (downwards) with a (vertical) pushing force until it is positioned on the stack being formed. The pushing force (orthogonal to the lay plane of the cell A) may in particular be ensured by pushing means 5 provided with a movable thrust unit with a translational motion.

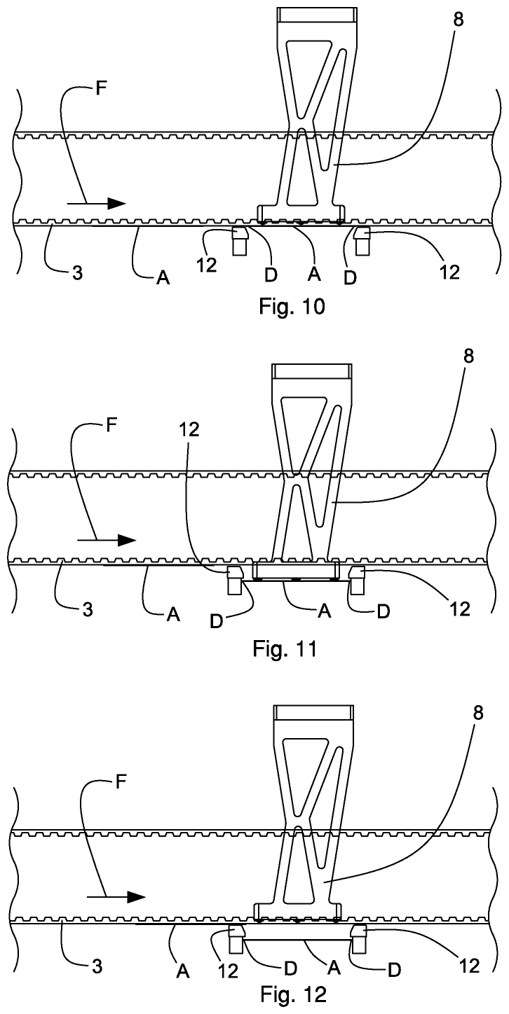

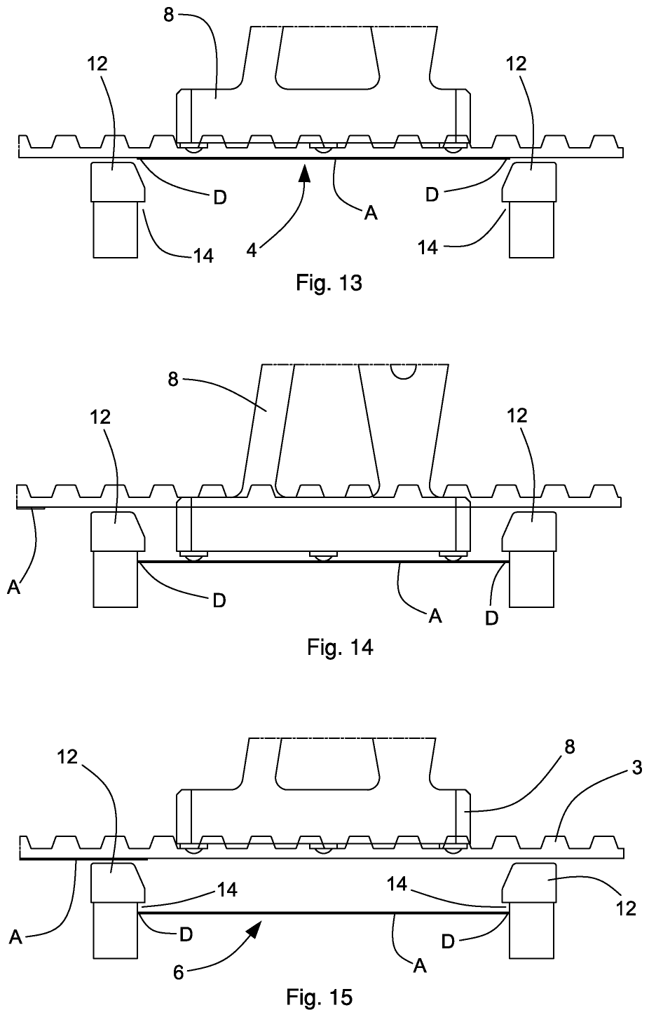

The thrust unit may comprise, as in this example, at least one rod 8 which has a (lower) end configured for pushing contacting the cell A arranged in the release zone 4. The movement of pushing means 5 will be coordinated with the advancement of cells A operated by feeding means 2 in such a way that, when a cell A arrives at the release zone 4, pushing means 5 can push the cell such to detach the cell from (suction) grip means which keep the cell in grip and to direct the cell A towards the passage opening defined by guide means 12 and hence towards the stacking zone 6. FIGS. 10 to 15 show three stages of the sequence of movement of pushing means 5 to direct the cell A towards the stacking zone 6 passing through guide means 12.

Guide means 12, due in particular to the fact that they comprise at least a sliding surface intended to sliding contact the perimeter flexible flap of the cell A, allow to efficiently guide the movement of the cell towards the stacking zone 6 and to settle the cell itself with great precision at the end of the stack being formed in the stacking zone 6, thus ensuring the exact superimposition of cells A and consequently the correct formation of the stack of cells A whereby the electrical energy storage device will then be produced.

Precision in positioning is improved in that guide means comprise several guide portions, separated and distant from each other, each one provided with a sliding surface, whereby the sliding friction is not excessive and it is in any case enough to efficiently guide the cell A descent in order to perform the desired positioning of the cell itself on the stack.

Precision in positioning is further improved in that guide means may comprise at least an initial guide portion which operates on two opposite sides of the cell A and at least a subsequent guide portion which operates on other two sides opposite the cell A and which starts to operate after the guide portion has started operating, whereby a position settlement or adjustment of the cell (A) takes place at first in a first adjustment direction and then a position settlement or adjustment of the cell A takes places in a second adjustment direction that is transversal (orthogonal) to the first adjustment direction.

Guide means 12 may be configured in such a way as to align the cell A with respect to the lay plane of the cell itself by operating at first in an adjustment direction and then in another adjustment direction, where the two adjustment directions are co-planar between them and with respect to the aforesaid lay plane.

Pushing means 5 may be configured in such a way as to move the cell A in a direction that is orthogonal to the lay plane of the cell itself.

The action of guide means 12, which direct the cell A with precision in positioning towards the stacking zone 6, is also encouraged by the action of pushing means 5 which push the cell A (from above downwards) by guide means 12, in particular with a pushing force that is orthogonal or mainly orthogonal to the lay plane of the cell A.

Pushing means 5 may in particular be configured to perform a stroke (in particular downwards) until they pass past guide means 12, for instance to arrive to the cavity/s underlying guide means 12 (adapted to define an end-of-guide free space or gap) where the flexible edges or flaps of cell A can freely elastically return in an unbent position.

Pushing means 5 may in particular be configured to perform a (downward) movement to take the cell A to the end (top) of the stack being formed in the stacking zone 6.

Pushing means 5 are in particular configured to exert a force on the cell A which determines an acceleration thereof in the movement from the release zone 4 to the stacking zone 6.

1. Assembling method, comprising the steps of:
feeding flat shaped cells (A), arranged one after the other in a feed direction (F) to a release zone (4);
pushing a cell (A) arrived in said release zone (4) to make it move from said release zone (4) to a stacking zone (6) where the cells (A) form a stack of cells superimposed on each other;
during said pushing, at least one portion of a perimeter flexible flap of said cell (A) is bent due to contact with guide means (12) and then, continuing said pushing, said contact terminates whereby an elastic return of said portion of flap occurs.

2. Method according to claim 1, wherein said cell (A) arrives in said release zone (4) with horizontal arrangement and from here it is pushed downwards to make it perform a descent towards said stacking zone (6), whereby, during said descent, said flexible flap portion is bent upwards due to contact with said guide means (12).

3. Method according to claim 1, wherein said contact occurs on at least one perimeter side of said cell (A) in at least two zones distant from each other and separated from one another by a portion of said side where the contact does not occur.

4. Method according to claim 1, wherein said guide means (12) delimits at least in part an opening for the passage of said cell (A) and wherein said contact occurs on a contact surface of said guide means (12) which is inclined towards the moving direction of the cell (A) and towards a central area of said opening.

5. Method according to claim 1, wherein said contact occurs in at least one perimeter first side of said cell (A) and at least one perimeter second side of said cell (A) opposite said first side.

6. Method according to claim 5, wherein said contact occurs in at least two first zones arranged on said perimeter first side and in at least two second zones arranged on said perimeter second side, said two first zones being distant from each other and separated from each other by a portion of side where the contact does not occur, said two second zones being distant from each other and separated from one another by a portion of side where the contact does not occur.

7. Method according to claim 5, wherein said contact occurs at least in a perimeter third side of said cell and at least in a perimeter fourth side of said cell opposite said third side.

8. Method according to claim 7, wherein said contact occurs in at least two third zones arranged on said perimeter third side and in at least two fourth zones arranged on said perimeter fourth side, said two third zones being distant from each other and separated from each other by a portion of side where the contact does not occur, said two fourth zones being distant from each other and separated from one another by a portion of side where the contact does not occur.

9. Method according to claim 1, wherein, during said pushing, at first two opposite sides of the perimeter flexible flap of said cell (A) begin to contact an initial guide portion of said guide means (12) and at a later time two opposite sides of the perimeter flexible flap of said cell (A) begin to contact a subsequent guide portion of said guide means (12), whereby a settlement or adjustment of the position of the cell (A) takes place first in a first adjustment direction and then in a second adjustment direction.

10. Method according to claim 1, wherein:
said stacking zone (6) is arranged vertically below said release zone (4); and/or
during said feeding, said cells (A) are kept in grip by movable conveyor means provided with suction means; and/or
said cell (A) arrives in said release zone (4) with a lay and from there it is pushed with a pushing force orthogonal to said lay.

11. Assembling apparatus (1), in particular for implementing a method according to claim 1, said apparatus comprising:
feeding means (2) configured to feed flat shaped cells (A) arranged one after the other;
a release zone (4) at which cells (A) arrive fed by said feeding means (2);
pushing means (5) configured to push a cell (A) arrived at said release zone (4) towards a stacking area (6);
a stacking zone (6) where the cells (A) coming from said release zone (4) are stacked;
guide means (12) arranged in a portion of the displacement of the cells (A) from said release zone (4) to said stacking zone (12) and configured to sliding contact at least one portion of a perimeter flexible flap of the cell (A) during the movement of the cell and to bend the portion of flap by effect of the contact, said guide means (12) being further configured in such a way that the contact ends continuing the movement of the cell (A), so that an elastic return of the portion of perimeter flap of the cell (A) can occur.

12. Apparatus according to claim 11, wherein said guide means (12) comprises at least two contact portions distant and separated from each other and configured so as to contact at least one perimeter side of the cell (A) in at least two zones distant from each other and separated from each other by a zone where the contact does not occur.

13. Apparatus according to claim 11, wherein said guide means (12) delimits at least partly an opening for the passage of the cell (A) during the movement of the cell (A), said guide means (12) comprising a contact surface configured for contacting at least partly the flexible perimeter edge of the cell, said contact surface being inclined towards the direction of movement and towards a central area of said opening.

14. Apparatus according to claim 11, wherein said pushing means (5) comprises at least one thrust unit provided with at least one or two rods (8) each of which has one end configured for a thrust contact with the cell (A) arranged in said release zone (4); said thrust unit being movable, in particular, with a translation motion; said thrust unit being, in particular, movable by driving motor means; said thrust unit being, in particular, connected to said motor means by a mechanism (10) configured to transform a rotary motion of a rotor of said motor means into a translational motion of said thrust unit; said mechanism (10) comprising, in particular, an articulated parallelogram.

15. Apparatus according to claim 11, wherein said guide means (12) comprises at least an initial guide portion and at least a subsequent guide portion configured in such a way that, during the movement of the cell (A), there are two opposite sides of the perimeter flexible flap of the cell (A) which begin to touch said initial guide portion and at a later time there are two opposite sides of the perimeter flexible flap of the cell (A) which begin to touch said subsequent guide portion, whereby a position adjustment of the cell (A) takes place at first in a first adjustment direction and then in a second adjustment direction.

16. Apparatus according to claim 11, wherein:
said guide means (12) is configured to contact the perimeter edge of the cell (A) at least on a perimeter first side of the cell (A) and at least on a perimeter second side of the cell (A) opposite the first side; and/or
said guide means (12) comprises at least two first contact portions configured to contact two first zones of a perimeter first side of the cell (A) and at least two second contact portions configured to contact two second zones of a perimeter second side of the cell (A), said two first contact portions being distant and separated from each other by a zone where contact does not occur, said two second contact portions being distant and separated from each other by a zone where contact does not occur; and/or
said guide means (12) comprises at least two third contact portions configured to contact two third zones of a perimeter third side of the cell and at least two fourth contact portions configured to contact two fourth zones of a perimeter fourth side of the cell, said two third contact portions being distant and separated from each other by a zone where contact does not occur, said two fourth contact portions being distant and separated from each other by a zone where contact does not occur; and/or
said stacking zone (6) is arranged vertically below said release zone (4); and/or
said feeding means (2) comprises movable conveyor means provided with suction means for keeping the cells (A) in grip.
